(19) United States
(12) Patent Application Publication
(10) Pub. No.: US 2012/0145956 A1
(43) Pub. Date: Jun. 14, 2012

(54) PLASMA MODIFICATION OF WATER-ABSORBING POLYMER STRUCTURES

(76) Inventors: Mirko Walden, Herten (DE); Christoph Loick, Tonisvorst (DE); Jürgen Erwin Lang, Karlsruhe (DE); Maciej Olek, Kahl (DE); Harald Schmidt, Mulheim an der Ruhr (DE)

(21) Appl. No.: 13/389,745

(22) PCT Filed: Aug. 18, 2010
(86) PCT No.: PCT/EP2010/062028

§ 371 Date: Feb. 9, 2012

(30) Foreign Application Priority Data
Sep. 11, 2009 (DE) 102009040949

(51) Int. Cl. C08F 220/06; B01J 19/18; C09K 3/00

(52) U.S. Cl. 252/194; 525/344; 422/134

(57) ABSTRACT

The present invention relates to a process for producing surface-modified water-absorbing polymer structures, comprising the process steps of providing a multitude of water-absorbing polymer structures and treating the surface of the water-absorbing polymer structures with a plasma and mixing a filler with the water-absorbing polymer structures. The invention also relates to an apparatus for this process, to the surface-modified water-absorbing polymer structures obtainable by this process, to a composite comprising these surface-modified water-absorbing polymer structures and a substrate, to a process for producing a composite, to a composite obtainable by this process, to chemical products comprising these surface-modified water-absorbing polymer structures or the composite, and to the use of the surface-modified water-absorbing polymer structures or of the composite in chemical products.

The present invention relates to a process for producing surface-modified water-absorbing polymer structures, to the surface-modified water-absorbing polymer structures obtainable by this process, to a composite comprising these surface-modified water-absorbing polymer structures and a substrate, to a process for producing a composite, to a composite obtainable by this process, to chemical products comprising these surface-modified water-absorbing polymer structures or the composite, and to the use of the surface-modified water-absorbing polymer structures or of the composite in chemical products.

Superabsorbents are water-insoluble crosslinked polymers which are capable of absorbing large amounts of aqueous liquids, especially body fluids, preferably urine or blood, while swelling and forming hydrogels, and of retaining them under pressure. In general, these liquid absorptions are at least 10 times or even at least 100 times the dry weight of the superabsorbents or of the superabsorbent compositions of water. By virtue of these characteristic properties, these polymers find use principally in sanitary articles such as diapers, incontinence products or sanitary napkins. A comprehensive overview of superabsorbents and superabsorbent compositions, the use thereof and the production thereof is given by F. L. Buchholz and A. T. Graham (editors) in “Modern Superabsorbent Polymer Technology,” Wiley-VCH, New York, 1998.

The superabsorbents are prepared generally by the free-radical polymerization of usually partly neutralized monomers bearing acid groups, in the presence of crosslinkers. Through the selection of the monomer composition, of the crosslinkers and of the polymerization conditions, and of the processing conditions for the hydrogel obtained after the polymerization, it is possible to prepare polymers with different absorption properties. Further possibilities are offered by the preparation of graft polymers, for example using chemically modified starch, cellulose and polyvinyl alcohol according to DE-A-26 12 846.

The current trend in diaper construction is to produce even thinner constructions with reduced cellulose fiber content and increased superabsorbent content. The advantage of thinner constructions is exhibited not just in improved wear comfort but also in reduced costs in packaging and storage. With the trend toward ever thinner diaper constructions, the profile of requirements on the superabsorbents has changed significantly. Of crucial significance is now the ability of the hydrogel to conduct and distribute the liquid. Owing to the higher loading of the hygiene article (amount of superabsorbent per unit area), the polymer in the swollen state must not form a barrier layer for subsequent liquid (gel blocking). If the product has good transport properties, optimal exploitation of the overall hygiene article can be ensured.

In addition to the permeability of the superabsorbents (reported in the form of the “Saline Flow Conductivity—SFC”) and the absorption capacity under compressive stress, the absorption rate of the superabsorbent particles in particular (reported in amount of liquid absorbed per gram of superabsorbent per second) is also a crucial criterion which enables statements about whether an absorbent core which comprises this superabsorbent in a large concentration and has only a low fluff content is capable, on its first contact with liquids, of absorbing them rapidly (“first acquisition”). In the case of absorbent cores with a high superabsorbent content, this “first acquisition” depends, among other factors, on the absorption rate of the superabsorbent material.

In order to improve the absorption rate of superabsorbents, the prior art discloses various approaches. For instance, the surface area of the superabsorbent can be increased by using smaller superabsorbent particles with a correspondingly higher surface-volume ratio. The result of this, however, is that the permeability and also other performance characteristics of the superabsorbent, for example retention, are reduced. In order to avoid this problem, an increase in the surface area of the superabsorbent particles can also be achieved without reducing the particle diameter by, for example, producing superabsorbent particles with irregular shapes by pulverizing. For example, U.S. Pat. No. 5,118,719 and U.S. Pat. No. 5,145,713 also disclose dispersing blowing agents in the monomer solution during the polymerization, which release carbon dioxide in the course of heating. The porosity of the resulting superabsorbent provides a relatively large surface area in the polymer particles, which ultimately enables an increased absorption rate. U.S. Pat. No. 5,399,391 further discloses postcrosslinking such foamed superabsorbent particles on the surface, in order also to improve the absorption capacity under compressive stress in this way. However, the disadvantage of this approach is that, owing to the large surface area of the foamed superabsorbent particles, it is necessary to use the surface crosslinkers in an even greater amount compared to unfoamed superabsorbent particles, which inevitably also leads to an increased crosslinking density in the surface region. Too high a crosslinking density in the surface regions leads, however, to a reduction in the absorption rate.

It was an object of the present invention to overcome the disadvantages which arise from the prior art in connection with the production of water-absorbing polymer structures with high absorption rate.

More particularly, it was an object of the present invention to specify a process for producing superabsorbents, which enables the absorption rate of any selected precursor particles to be increased, preferably without any change in the particle size distribution.

More particularly, this process should be notable in that the use thereof increases the absorption rate of the superabsorbents, but the retention, i.e. the ability to retain absorbed liquid, is reduced to a minimum degree or at worst only slightly.

It is an additional object of the invention that the treatments of the surface of the superabsorbent particles have an at least neutral effect on the surface postcrosslinking with regard to the performance of the superabsorbent.

It was a further object of the present invention to provide superabsorbents with an increased absorption rate compared to superabsorbents known from the prior art, which at the same time have maximum retention. Furthermore, this profile of properties of the superabsorbents should change only slightly at worst, if at all, even in the course of prolonged storage, for example over several weeks.

A contribution to the achievement of the abovementioned objects is made by a process for producing surface-modified water-absorbing polymer structures, comprising the process steps of:
I) providing a multitude of water-absorbing polymer structures;
II) treating, preferably modifying, the surface of the water-absorbing polymer structures provided in process step I) with a plasma;
   wherein the water-absorbing polymer structures are mixed with one another during process step II). The process steps need not be in strict succession after the completion of each. Instead, the process steps, and likewise all steps described hereinafter, may overlap in terms of time.

In process step I) of the process according to the invention, a multitude of water-absorbing polymer structures is first provided, the term “multitude” as used herein preferably being understood to mean an amount of at least 1000, even more preferably at least 1 000 000 and most preferably at least 1 000 000 000.

Water-absorbing polymer structures preferred in accordance with the invention are fibers, foams or particles, preference being given to fibers and particles, and particular preference to particles.

The dimensions of polymer fibers preferred in accordance with the invention are such that they can be incorporated into or as yarns for textiles and also directly into textiles. It is preferred in accordance with the invention that the polymer fibers have a length in the range from 1 to 500 mm, preferably 2 to 500 mm and more preferably 5 to 100 mm, and a diameter in the range from 1 to 200 denier, preferably 3 to 100 denier and more preferably 5 to 60 denier.

The dimensions of polymer particles preferred in accordance with the invention are such that they have a mean particle size to ERT 420.2-02 in the range from 10 to 3000 μm, preferably 20 to 2000 μm and more preferably 150 to 850 μm. It is especially preferred that the proportion of the polymer particles with a particle size within a range from 300 to 600 μm is at least 30% by weight, more preferably at least 40% by weight and most preferably at least 50% by weight, based on the total weight of the water-absorbing polymer particles.

It is additionally preferred in accordance with the invention that the water-absorbing polymer structures provided in process step I) are based on partly neutralized, crosslinked acrylic acid. In this context, it is especially preferred that the inventive water-absorbing polymer structures are crosslinked polyacrylates which consist to an extent of at least 50% by weight, preferably to an extent of at least 70% by weight and further preferably to an extent of at least 90% by weight, based in each case on the weight of the water-absorbing polymer structures, of monomers bearing carboxylate groups. It is additionally preferred in accordance with the invention that the inventive water-absorbing polymer structures are based to an extent of at least 50% by weight, preferably to an extent of at least 70% by weight, based in each case on the weight of the water-absorbing polymer structures, on polymerized acrylic acid, which is preferably neutralized to an extent of at least 20 mol %, more preferably to an extent of at least 50 mol % and further preferably within a range from 60 to 85 mol %.

The water-absorbing polymer structures provided in process step I) are preferably obtainable by a process comprising the process steps of:
i) free-radically polymerizing an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), to obtain a polymer gel;
ii) optionally comminuting the hydrogel;
iii) drying the optionally comminuted hydrogel to obtain water-absorbing polymer particles;
iv) optionally grinding and screening off the water-absorbing polymer particles thus obtained;
v) optionally further surface modifying, preferably surface postcrosslinking, the water-absorbing polymer particles thus obtained, where this further surface modification may in principle precede, coincide with or follow the surface modification in process step II) of the process according to the invention.

In the process according to the invention, if a surface modification is effected, as a separate configuration in each case of the process according to the invention, this treatment can be carried out before, during, or else after the surface modification, where the periods of surface modification and of treatment may also overlap.

This multitude of configurations is possible by virtue of the usually minor degree of impairment of the surface-postcrosslinked polymer particle.

In process step i), an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), is initially free-radically polymerized to obtain a polymer gel. The monoethylenically unsaturated monomers bearing acid groups (α1) may be partly or fully, preferably partly, neutralized. The monoethylenically unsaturated monomers bearing acid groups (α1) are preferably at least 25 mol %, more preferably at least 50 mol % and further preferably 50-80 mol % neutralized. In this connection, reference is made to DE 195 29 348 A1, the disclosure of which is hereby incorporated by reference. Some or all of the neutralization may also follow the polymerization. In addition, the neutralization can be effected with alkali metal hydroxides, alkaline earth metal hydroxides, ammonia, and also carbonates and bicarbonates. In addition, any further base which forms a water-soluble salt with the acid is conceivable. Mixed neutralization with different bases is also conceivable. Preference is given to neutralization with ammonia and alkali metal hydroxides, particular preference to that with sodium hydroxide and with ammonia.

Moreover, in the inventive water-absorbing polymer structures, the free acid groups may predominate, such that this polymer structure has a pH in the acidic range. This acidic water-absorbing polymer structure can be at least partly neutralized by a polymer structure with free basic groups, preferably amine groups, which is basic compared to the acidic polymer structure. These polymer structures are referred to in the literature as “Mixed-Bed Ion-Exchange Absorbent Polymers” (MBIEA polymers) and are disclosed, inter alia, in WO 99/34843 A1. The disclosure of WO 99/34843 A1 is hereby incorporated by reference and is therefore considered to form part of the disclosure. In general, MBIEA polymers constitute a composition which firstly includes basic polymer structures which are capable of exchanging anions, and secondly an acidic polymer structure compared to the basic polymer structure, which is capable of exchanging cations. The basic polymer structure has basic groups and is typically obtained by the polymerization of monomers which bear basic groups or groups which can be converted to basic groups. These monomers are primarily those which have primary, secondary or tertiary amines or the corresponding phosphines or at least two of the above functional groups. This group of monomers includes especially ethyleneamine, allylamine, diallylamine, 4-aminobutene, alkyloxycyclines, vinylformamide, 5-aminopentene, carbodiimide, formaldacine, melamine and the like, and the secondary or tertiary amine derivatives thereof.

Preferred monoethylenically unsaturated monomers bearing acid groups (α1) are preferably those compounds specified as ethylenically unsaturated monomers bearing acid groups (α1) in WO 2004/037903 A2, which is hereby incorporated by reference and is therefore considered to be part of the disclosure. Particularly preferred monoethylenically unsaturated monomers bearing acid groups (α1) are acrylic acid and methacrylic acid, acrylic acid being the most preferred.

The monoethylenically unsaturated monomers (α2) used, which are copolymerizable with the monomers (α1), may be acrylamides, methacrylamides or vinylamides. Further preferred comonomers are especially those which are specified as comonomers (α2) in WO 2004/037903 A2.

The crosslinkers (α3) used are preferably likewise those compounds specified in WO 2004/037903 A2 as crosslinkers (α3). Among these crosslinkers, particular preference is given to water-soluble crosslinkers. The most preferred are N,N′-methylenebisacrylamide, polyethylene glycol di(meth)acrylates, triallylmethylammonium chloride, tetraallylammonium chloride, and allyl nonaethylene glycol acrylate prepared with 9 mol of ethylene oxide per mole of acrylic acid.

In addition to the monomers (α1) and optionally (α2) and optionally the crosslinker (α3), the monomer solution may also include water-soluble polymers (α4). Preferred water-soluble polymers comprise partly or fully hydrolyzed polyvinyl alcohol, polyvinylpyrrolidone, starch or starch derivatives, polyglycols or polyacrylic acid. The molecular weight of these polymers is uncritical provided that they are water-soluble. Preferred water-soluble polymers are starch or starch derivatives or polyvinyl alcohol. The water-soluble polymers, preferably synthetic water-soluble polymers such as polyvinyl alcohol, can not only serve as the graft base for the monomers to be polymerized. It is also conceivable to mix these water-soluble polymers with the polymer gel only after the polymerization, or with the already dried, water-absorbing polymer gel.

In addition, the monomer solution may also comprise assistants (α5), which assistants include especially the initiators or complexing agents which may be required for the polymerization, for example EDTA.

Useful solvents for the monomer solution include water, organic solvents or mixtures of water and organic solvents, the selection of the solvent depending especially also on the manner of the polymerization.

The relative amount of monomers (α1) and (α2) and of crosslinkers (α3) and water-soluble polymers (α4) and assistants (α5) in the monomer solution is preferably selected such that the water-absorbing polymer structure obtained after drying in process step iii) is based
to an extent of 20 to 99.999% by weight, preferably to an extent of 55 to 98.99% by weight and more preferably to an extent of 70 to 98.79% by weight on the monomers (α1),
to an extent of 0 to 80% by weight, preferably to an extent of 0 to 44.99% by weight and more preferably to an extent of 0.1 to 44.89% by weight on the monomers (α2),
to an extent of 0 to 5% by weight, preferably to an extent of 0.001 to 3% by weight and more preferably to an extent of 0.01 to 2.5% by weight on the crosslinkers (α3),
to an extent of 0 to 30% by weight, preferably to an extent of 0 to 5% by weight and more preferably to an extent of 0.1 to 5% by weight on the water-soluble polymers (α4),
to an extent of 0 to 20% by weight, preferably to an extent of 0 to 10% by weight and more preferably to an extent of 0.1 to 8% by weight on the assistants (α5), and
to an extent of 0.5 to 25% by weight, preferably to an extent of 1 to 10% by weight and more preferably to an extent of 3 to 7% by weight on water (α6),
   where the sum of the weights (α1) to (α6) is 100% by weight. Optimal values for the concentration, especially of the monomers, crosslinkers and water-soluble polymers, in the monomer solution can be determined by simple preliminary tests or else inferred from the prior art, especially publications U.S. Pat. No. 4,286,082, DE-A-27 06 135, U.S. Pat. No. 4,076,663, DE-A-35 03 458, DE 40 20 780 C1, DE-A-42 44 548, DE-A-43 33 056 and DE-A-44 18 818. For the free-radical polymerization of the monomer solution, useful polymerization processes may in principle be all of those known to those skilled in the art. For example, mention should be made in this context of bulk polymerization, which is preferably effected in kneading reactors such as extruders, solution polymerization, spray polymerization, inverse emulsion polymerization and inverse suspension polymerization.

The solution polymerization is preferably performed in water as the solvent. The solution polymerization can be effected continuously or batch wise. The prior art discloses a broad spectrum of possible variations with regard to reaction conditions, such as temperatures, type and amount of the initiators, and the reaction solution. Typical processes are described in the following patents: U.S. Pat. No. 4,286,082, DE-A-27 06 135 A1, U.S. Pat. No. 4,076,663, DE-A-35 03 458, DE 40 20 780 C1, DE-A-42 44 548, DE-A-43 33 056, DE-A-44 18 818. The disclosures are hereby incorporated by reference and are therefore considered to form part of the disclosure.

The polymerization is triggered by an initiator, as is generally customary. The initiators used to initiate the polymerization may be all initiators which form free radicals under the polymerization conditions and are typically used in the production of superabsorbents. Initiation of the polymerization by the action of electron beams on the polymerizable aqueous mixture is also possible. The polymerization can, however, also be triggered in the absence of initiators of the type mentioned above by the action of high-energy radiation in the presence of photoinitiators. Polymerization initiators may be present dissolved or dispersed in the monomer solution. Useful initiators include all compounds which decompose to free radicals and are known to the person skilled in the art. These include especially those initiators which are already mentioned in WO-A-2004/037903 as possible initiators. Particular preference is given to producing the water-absorbing polymer structures using a redox system consisting of hydrogen peroxide, sodium peroxodisulphate and ascorbic acid.

Inverse suspension and emulsion polymerization can also be employed to produce the inventive water-absorbing polymer structures. In these processes, an aqueous, partly neutralized solution of the monomers (α1) and (α2), optionally including the water-soluble polymers (α4) and assistants (α5), is dispersed with the aid of protective colloids and/or emulsifiers in a hydrophobic organic solvent, and the polymerization is initiated by means of free-radical initiators. The crosslinkers (α3) are either dissolved in the monomer solution and are metered in together with it, or else are added separately and optionally during the polymerization. Optionally, a water-soluble polymer (α4) is added as a graft base via the monomer solution, or by direct initial charging into the oil phase. Subsequently, the water is removed from the mixture as an azeotrope and the polymer is filtered off.

In addition, both in the case of solution polymerization and in the case of inverse suspension and emulsion polymerization, the crosslinking can be effected by copolymerization of the polyfunctional crosslinker (α3) dissolved in the monomer solution and/or by reaction of suitable crosslinkers with functional groups of the polymer during the polymerization steps.

The processes are described, for example, in publications U.S. Pat. No. 4,340,706, DE-A-37 13 601, DE-A-28 40 010 and WO-A-96/05234, the corresponding disclosure of which is hereby incorporated by reference.

In process step ii), the polymer gel obtained in process step i) is optionally comminuted, this comminution being effected especially when the polymerization is performed by means of a solution polymerization. The comminution can be effected by means of comminution apparatus known to those skilled in the art, for instance a meat grinder.

In process step iii), the polymer gel which has optionally been comminuted beforehand is dried. The polymer gel is preferably dried in suitable driers or ovens. Examples include rotary tube ovens, fluidized bed driers, pan driers, paddle driers or infrared driers. It is additionally preferred in accordance with the invention that the polymer gel is dried in process step iii) down to a water content of 0.5 to 25% by weight, preferably of 1 to 10% by weight, the drying temperatures typically being within a range from 100 to 200° C.

In process step iv), the water-absorbing polymer structures obtained in process step iii), especially when they have been obtained by solution polymerization, can be ground and screened off to the desired particle size specified at the outset. The dried water-absorbing polymer structures are ground preferably in suitable mechanical comminution apparatus, for example a ball mill, whereas the screening-off can be effected, for example, by using screens with suitable mesh size.

In process step v), the optionally ground and screened-off water-absorbing polymer structures may be surface-modified, which surface modification preferably includes surface postcrosslinking, and which surface postcrosslinking in process step v) may in principle precede, coincide with or follow the plasma treatment in process step II) of the process according to the invention.

For the optional surface postcrosslinking, the dried and optionally ground and screened-off (and optionally also already plasma-modified) water-absorbing polymer structures from process step iii), iv) or II), or else the as yet undried but preferably already comminuted polymer gel from process step ii), are contacted with a preferably organic, chemical surface postcrosslinker. Especially when the postcrosslinker is not liquid under the postcrosslinking conditions, it is preferably contacted with the water-absorbing polymer structures or the polymer gel in the form of a fluid comprising the postcrosslinker and a solvent. The solvents used are preferably water, water-miscible organic solvents, for instance methanol, ethanol, 1-propanol, 2-propanol or 1-butanol or mixtures of at least two of these solvents, water being the most preferred solvent. It is additionally preferred that the postcrosslinker is present in the fluid in an amount within a range from 5 to 75% by weight, more preferably 10 to 50% by weight and most preferably 15 to 40% by weight, based on the total weight of the fluid.

The contacting of the water-absorbing polymer structure or of the optionally comminuted polymer gel with the fluid including the postcrosslinker is effected preferably by good mixing of the fluid with the polymer structure or the polymer gel.

Suitable mixing units for applying the fluid are, for example, the PattersonKelley mixer, DRAIS turbulent mixers, Lodige mixers, Ruberg mixers, screw mixers, pan mixers and fluidized bed mixers, and also continuous vertical mixers in which the polymer structure is mixed at high frequency by means of rotating blades (Schugi mixer).

The polymer structure or the polymer gel is contacted in the course of postcrosslinking preferably with at most 20% by weight, more preferably with at most 15% by weight, further preferably with at most 10% by weight, even further preferably with at most 5% by weight, of solvent, preferably water.

In the case of polymer structures in the form of preferably spherical particles, it is additionally preferred in accordance with the invention that the contacting is effected in such a way that only the outer region but not the inner region of the particulate polymer structures is contacted with the fluid and hence the postcrosslinker.

Postcrosslinkers are preferably understood to mean compounds which have at least two functional groups which can react with functional groups of a polymer structure in a condensation reaction (=condensation crosslinkers), in an addition reaction or in a ring-opening reaction. Preferred post crosslinkers are those specified in WO-A-2004/037903 as crosslinkers of crosslinker classes II.

Among these compounds, particularly preferred postcrosslinkers are condensation crosslinkers, for example diethylene glycol, triethylene glycol, polyethylene glycol, glycerol, polyglycerol, propylene glycol, diethanolamine, triethanolamine, polyoxypropylene, oxyethylene-oxypropylene block copolymers, sorbitan fatty acid esters, polyoxyethylene sorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one and 1,3-dioxolan-2-one.

Once the polymer structures or the polymer gels have been contacted with the postcrosslinker or with the fluid including the postcrosslinker, they are heated to a temperature in the range from 50 to 300° C., preferably 75 to 275° C. and more preferably 150 to 250° C., such that, preferably as a result of which, the outer region of the polymer structures is more highly crosslinked compared to the inner region (=postcrosslinking), and, when polymer gels are used, they are simultaneously also dried. The duration of the heat treatment is limited by the risk that the desired profile of properties of the polymer structures is destroyed owing to the action of heat.

Moreover, the surface modification in process step v) may also include treatment with a compound containing aluminum, preferably Al³⁺ ions, preference being given to performing this treatment simultaneously with the surface postcrosslinking by contacting a preferably aqueous solution including the postcrosslinker and the compound including aluminum, preferably Al³⁺ ions, with the water-absorbing polymer structures and then heating.

It is preferred that the compound containing aluminum is contacted with the water-absorbing polymer structures in an amount within a range from 0.01 to 30% by weight, more preferably in an amount within a range from 0.1 to 20% by weight and further preferably in an amount within a range from 0.3 to 5% by weight, based in each case on the weight of the water-absorbing polymer structures.

Preferred aluminum-containing compounds are water-soluble compounds containing Al³⁺ ions, for instance AlCl₃×6H₂O, NaAl(SO₄)₂×12H₂O, KAl(SO₄)₂×12H₂O or Al₂(SO₄)₃×14-18H₂O, aluminum lactate or else water-insoluble aluminum compounds, for instance aluminum oxides, for example Al₂O₃, or aluminates. Particular preference is given to using mixtures of aluminum lactate and aluminum sulphate.

In process step II) of the process according to the invention, the water-absorbing polymer structures provided in process step I) are modified with a plasma, wherein the water-absorbing polymer structures are mixed with one another during process step II).

The term “plasma,” as used herein, is understood to mean an at least partly ionized gas which contains a significant proportion of free charge carriers such as ions or electrons. Such a plasma can be generated, for example, with the aid of electrical glow discharges by means of direct current, low frequency, radiofrequency or microwave excitation, particular preference being given in accordance with the invention to the generation of a plasma by means of low-frequency excitation. The excitation frequency is more preferably within a range from 1 to 10¹¹ Hz, even more preferably within a range from 1 to 10¹⁰ Hz and most preferably within a range from 1 Hz to 100 kHz.

To generate the plasma in the process according to the invention, it is possible to use all gases which appear suitable to the person skilled in the art for generation of a plasma. To increase the absorption rate of the water-absorbing polymer structures, however, it has been found to be particularly advantageous to use a nitrogen plasma, an air plasma or a water vapor plasma. If, for example, the absorption properties of the water-absorbing polymers are to be varied, it is preferable to employ a noble gas plasma, for example a neon plasma or an argon plasma.

In the generation of the plasma, the aforementioned gases are preferably used with a specific gas flow rate within a range from 1 to 1000 ml/min, more preferably within a range from 10 to 200 ml/min and most preferably within a range from 50 to 100 ml/min.

It is additionally preferred that the surface of the water-absorbing polymer structures provided in process step I) is treated with the plasma within a range from 10⁻⁶ s to 10⁶ sec, more preferably within a range from 10 to 360 min and most preferably within a range from 30 to 90 min, the duration of the treatment with the plasma depending more particularly on the amount of the water-absorbing polymer structures used and on the power fed into the plasma.

Furthermore, it is preferred in accordance with the invention that the plasma is a low-pressure plasma. In this context, it is especially preferred that the surface of the water-absorbing polymer structures provided in process step I) is modified with the plasma at an absolute pressure within a range from 10⁻⁶ to 5 bar, more preferably within a range from 10⁻⁴ to 2 bar and most preferably within a range from 10⁻⁴ to 10⁻² bar.

In the process according to the invention, the water-absorbing polymer structures, during the modification thereof by the above-described plasma, are mixed with one another, the term “mixing” preferably being understood to mean any measure which leads to relative motion of the water-absorbing particles with respect to one another.

The mixing apparatus used for this purpose may be any mixing apparatus known to those skilled in the art, in which a plasma can be generated within the mixing space by suitable modifications, such that the surfaces of the water-absorbing polymer structures present in the mixing chamber are constantly exposed to the plasma during the mixing. Useful apparatus here includes drum mixers, PattersonKelley mixers, DRAIS turbulence mixers, Lödige mixers, Ruberg mixers, screw mixers, pan mixers, fluidized bed mixers, and continuous vertical mixers (Schugi mixers), which have been modified such that a high-frequency alternating electrical field is generated between two electrodes by means of a generator, in order to convert a gas present in the mixing chamber to the plasma state by preferably capacitative introduction of an electrical field, a phase-shifted plasma also being an option.

In a particular embodiment of the process according to the invention, however, the water-absorbing polymer structures are modified in process step II) in a rotating drum, preferably rotating about a horizontal axis, in which a plasma is generated. The electrodes which serve to generate the plasma are mounted at two opposite sides of the rotating drum, parallel to the axis of rotation about which the drum rotates.

When the drum is in the form of a cylinder of length L and circumference U, it is especially advantageous in accordance with the invention when the two opposite electrodes are each in approximately semicircular form, in which case the two electrodes, when they are arranged opposite one another, together cover at least 75%, more preferably at least 90% and most preferably at least 95% of the circumference of the cylinder, and extend over a length of at least 75%, more preferably at least 90% and most preferably at least 95% of the length of the cylinder L. In this way, it can be ensured that substantially the entire interior of the rotating drum is filled by the plasma.

In addition to the above-described mixing apparatus, it is also possible in principle to use a fall tower, for example, in which the water-absorbing polymer structures are in freefall for a defined distance. On the outside of this fall tower are again provided electrodes arranged opposite one another, by means of which a plasma can be generated within the fall tower. Since the polymer structures are mixed with one another at least to a certain degree as a result of collisions of the water-absorbing polymer structures with one another in such a fall tower, such a configuration of the plasma treatment is also encompassed by the process according to the invention. In addition to this fall tower, especially fluidized bed mixers in which a plasma can be generated can also be used in the process according to the invention.

It has been found that the absorption rate of the water-absorbing polymer structures can particularly be enhanced by the plasma treatment especially when the amount of water-absorbing polymer structures is limited and a drum rotating about a horizontal axis is used. It has been found to be especially advantageous when the water-absorbing polymer structures are used in an amount of at most 0.8 g/cm³, more preferably at most 0.75 g/cm³ and most preferably at most 0.5 g/cm³ of drum volume.

In addition, it has been found to be particularly advantageous when the water-absorbing polymer structures are mixed before or during process step II) with 0.001 to 5% by weight, more preferably 0.1 to 2.5% by weight and most preferably 0.25 to 1% by weight, based in each case on the total weight of the water-absorbing polymer structures, of a filler. The filler may be present in atomic monolayers, preference being given to 1 to 10 of these monolayers. Useful fillers include especially Si—O compounds, preferably zeolites, fumed silicas such as Aerosils®.

In addition, it is preferred in one configuration of the process according to the invention that the multitude of water-absorbing polymer structures is provided in process step I) mixed with a multitude of inorganic particles. Useful inorganic particles include in principle all of those which appear to be suitable to the person skilled in the art for mixing with water-absorbing polymer structures. Among these, oxides are preferred, particular preference being given to oxides of group IV, and further preference among these being given to silicon oxides. Among the silicon oxides, preference is given to zeolites, fumed silicas such as Aerosils® or Sipernat®, preferably Sipernat®. The inorganic particles may be used in any amounts which appear suitable to the person skilled in the art for improvement of the properties of the water-absorbing polymer structure. Preference is given to using the inorganic particles in an amount in the range from 0.001 to 15% by weight, preferably within a range from 0.01 to 10% by weight and more preferably within a range from 2 to 7% by weight, based in each case on the water-absorbing polymer structure particles. In addition, the inorganic particles may be used in all particle sizes which appear suitable to the person skilled in the art for improving the properties of the water-absorbing polymer structure. Preference is given to inorganic particles with a mean particle size to ASTM C2690 within a range from 0.001 to 100 μm, preferably within a range from 0.01 to 50 μm and more preferably within a range from 0.1 to 15 μm.

A further contribution to the present invention is made by an apparatus for producing a plasma-treated water-absorbing polymer structure, comprising the following apparatus parts in fluid-conducting connection with one another and in direct or indirect succession:
V1 a polymerization region,
V2 a finishing region,
V3 a plasma treatment region,
   where the plasma treatment region includes a plasma source and a mixing apparatus, preferably a rotating mixing apparatus.

Apparatus for producing absorbent polymer structures is common knowledge. For example, reference is made here to WO 05/122075 A1, in which the most important apparatus constituents, more particularly the polymerization region and the finishing region, are shown with many details. The polymerization region preferably includes a belt or screw extrusion polymerization apparatus. The finishing region preferably includes a drying and comminution apparatus.

In a further configuration of the apparatus, a surface crosslinking region is provided upstream or downstream of the plasma treatment region. In WO 05/122075 A1, further details of the surface postcrosslinking region, referred to therein as the postcrosslinking region, are also disclosed. Reference is therefore made to WO 02/122075 A1 in connection with further apparatus details.

In addition, the embodiments within the context of the process according to the invention also apply to the inventive apparatus. For instance, it is preferable to use the inventive apparatus for the process according to the invention. Moreover, “in fluid-conducting connection” is understood to mean that liquids, gels, powders or other free-flowing phases can be moved into the individual regions. This can be accomplished by means of lines, tubes or channels, and also by means of conveyors or pumps.

A contribution to the achievement of the abovementioned objects is also made by surface-modified water-absorbing polymer structures which are obtainable by the above-described process.

In a particular configuration of the inventive surface-modified water-absorbing polymer structures, they feature an FSR, determined by the test method described herein, of at least 0.3 g/g/sec, more preferably at least 0.32 g/g/sec, further preferably at least 0.34 g/g/sec, even further preferably 0.36 g/g/sec and most preferably at least 0.38 g/g/sec. In general, 0.8 or else 1 g/g/sec is not exceeded.

In addition, the water-absorbing polymer structures according to this particular configuration are characterized by a retention, determined by the test method described herein, of at least 26.5 g/g, more preferably at least 27.5 g/g and most preferably at least 28.5 g/g. In general, 40 or else 42 g/g is not exceeded.

In a further particular configuration of the inventive surface-modified water-absorbing polymer structures, they feature an absorption under pressure, determined by the test method described herein, of at least 20 g/g, more preferably at least 23 g/g and most preferably at least 24 g/g. In general, 30 or else 32 g/g is not exceeded.

A further contribution to the achievement of the objects described at the outset is made by a composite comprising the inventive surface-modified water-absorbing polymer structures and a substrate. It is preferred that the surface-modified water-absorbing polymer structures and the substrate are bonded to one another in a fixed manner. Preferred substrates are polymer films, for example of polyethylene, polypropylene or polyamide, metals, nonwovens, fluff, tissues, wovens, natural or synthetic fibers, or other foams. It is additionally preferred in accordance with the invention that the composite comprises at least one region which includes the inventive surface-modified water-absorbing polymer structures in an amount in the range from about 15 to 100% by weight, preferably about 30 to 100% by weight, more preferably from about 50 to 99.99% by weight, further preferably from about 60 to 99.99% by weight and even further preferably from about 70 to 99% by weight, based in each case on the total weight of the region of the composite in question, which region preferably has a size of at least 0.01 cm³, preferably at least 0.1 cm³ and most preferably at least 0.5 cm³.

A particularly preferred embodiment of the inventive composite involves a flat composite as described in WO-A-02/056812 as an “absorbent material”. The disclosure of WO-A-02/056812, especially with regard to the exact structure of the composite, the basis weight of its constituents and its thickness, is hereby incorporated by reference and constitutes part of the disclosure of the present invention.

A further contribution to the achievement of the objects cited at the outset is provided by a process for producing a composite, wherein the inventive surface-modified water-absorbing polymer structures and a substrate and optionally an additive are contacted with one another.

The substrates used are preferably those substrates which have already been mentioned above in connection with the inventive composite.

A contribution to the achievement of the objects cited at the outset is also made by a composite obtainable by the process described above, which composite preferably has the same properties as the above-described inventive composite.

A further contribution to the achievement of the objects cited at the outset is made by chemical products comprising the inventive surface-modified water-absorbing polymer structures or an inventive composite. Preferred chemical products are especially foams, moldings, fibers, foils, films, cables, sealing materials, liquid-absorbing hygiene articles, especially diapers and sanitary napkins, carriers for plant growth- or fungal growth-regulating compositions or active crop protection ingredients, additives for building materials, packaging materials or soil additives.

The use of the inventive surface-modified water-absorbing polymer structures or of the inventive composite in chemical products, preferably in the aforementioned chemical products, especially in hygiene articles such as diapers or sanitary napkins, and the use of the superabsorbent particles as carriers for plant growth- or fungal growth-regulating compositions or active crop protection ingredients, also makes a contribution to the achievement of the objects cited at the outset. In the case of use as a carrier for plant growth- or fungal growth-regulating compositions or active crop protection ingredients, it is preferred that the plant growth- or fungal growth-regulating compositions or active crop protection ingredients can be released over a period controlled by the carrier.

The invention is now illustrated in detail with reference to figures, test methods and non-limiting examples.

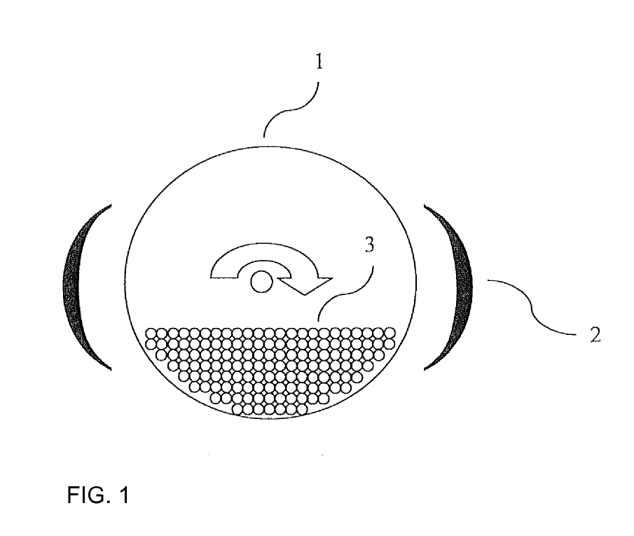

FIG. 1 shows a first configuration of an apparatus configured as a drum, which can be used for performance of the process according to the invention.

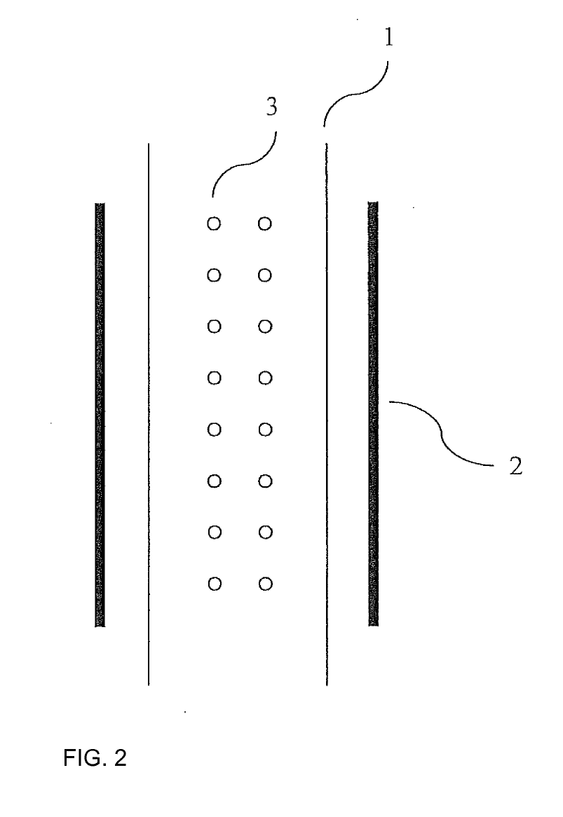

FIG. 2 shows a second configuration of an apparatus configured as a fall tower, which can be used for performance of the process according to the invention.

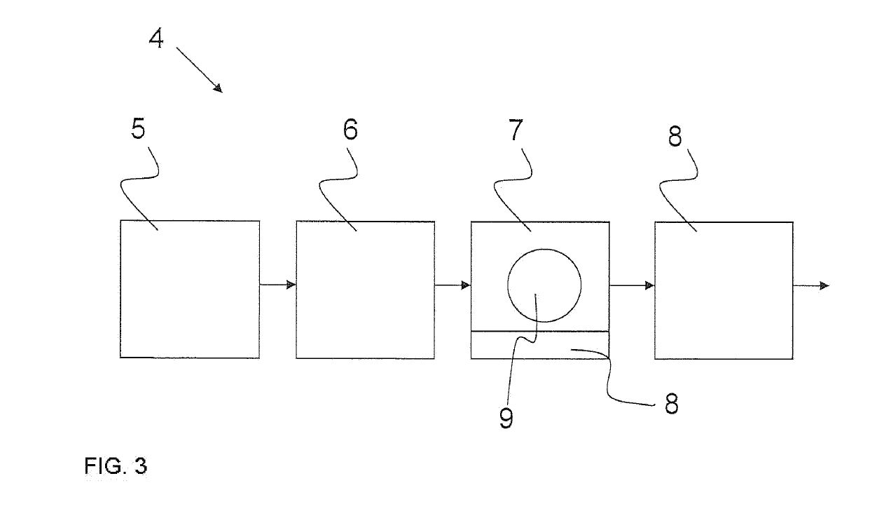

FIG. 3 shows a configuration of an inventive polymerization apparatus which can be used for performance of the process according to the invention.

In the embodiment of the process according to the invention shown in FIG. 1, the water-absorbing polymer structures 3 are initially charged in a drum 1 which rotates about a horizontal axis. Outside the drum are arranged two opposite electrodes 2, by means of which a plasma can be generated in the interior of the drum 1. Within the drum, stirrer paddles or other apparatus constituents which enable better mixing of the water-absorbing polymer structures may be provided (not shown in FIG. 1).

In the embodiment of the process according to the invention shown in FIG. 2, the water-absorbing polymer structures 3 fall downward within a fall tower 1. On the way downward, they pass through a plasma which is generated by two opposite electrodes 2 outside the fall tower 1.

FIG. 3 shows an illustrative embodiment of an inventive apparatus 4. Therein, a polymerization region 5 is followed by a finishing region 6, which is followed by a plasma treatment region 7, which is followed by a surface crosslinking region. Apart from further regions which may be provided between the regions stated here, the plasma treatment region 7 has a plasma source 8 and a mixing apparatus 10. The plasma treatment region 7 may be configured as shown in FIG. 1 or 2. In addition, further details regarding the configuration of the regions outside the plasma treatment region are disclosed in WO 05/722075 A1.

### Test Methods

### Determination of Absorption Rate

The absorption rate is determined via the measurement of the “free swell rate FSR” by the test method described in EP-A-0 443 627 on page 12. The determination is effected for the particle fraction within a range from 300 to 600 μm.

### Determination of Absorption Under Pressure

The absorption against a pressure of 0.7 psi (about 50 g/cm²), referred to as “AAP”, is determined to ERT 442.2-02, where “ERT” stands for “EDANA recommended test” and “EDANA” for “European Disposables and Nonwovens Association”. The determination is effected for the particle fraction within a range from 300 to 600 μm.

### Determination of Retention

The retention, referred to as “CRC” is determined to ERT 441.2-02. The determination is effected for the particle fraction within a range from 300 to 600 μm.

### EXAMPLES

### Polymer Structures (Powder A)

A monomer solution consisting of 320 g of acrylic acid which has been neutralized to an extent of 75 mol % with sodium hydroxide solution (266.41 g of 50% NaOH), 400.66 g of water, 0.508 g of polyethylene glycol-300 diacrylate, 1.037 g of monoallyl polyethylene glycol-450 monoacrylate is freed of dissolved oxygen by purging with nitrogen and cooled to the start temperature of 7° C. Once the start temperature has been attained, an initiator solution is added (0.3 g of sodium peroxodisulphate in 5 g of water, 0.007 g of 35% hydrogen peroxide solution in 5 g of water and 0.015 g of ascorbic acid in 1.5 g of water). An exothermic polymerization reaction took place. The adiabatic end temperature was approx. 105° C. The hydrogel formed was comminuted with a meat grinder and dried in a forced-air drying cabinet at 150° C. for 2 hours. The dried polymer was first crushed coarsely, ground by means of an SM 100 cutting mill with a 2 mm Conidur perforation, and screened to give a powder having a particle size of 300 to 600 μm (powder A).

### Postcrosslinked Polymer Structures (Polymer B)

100 g of powder A are mixed with a solution of 1.0 g of ethylene carbonate, 0.25 g of Al₂(SO₄)₃×14H₂O, 0.3 g of aluminum lactate and 3.0 g of deionized water. This is done by applying the solution with a syringe (0.45 mm cannula) to the polymer powder present in a mixer. The coated powder is then heated in a forced-air drying cabinet at 180° C. for 30 minutes (powder B).

### Example 1

In a drum which rotates about a horizontal axis and is shown in FIG. 1 as a cross-sectional diagram, 15 g of water-absorbing polymer structures are used as the starting material. Within the rotating drum (a DURAN® glass bottle from Schott Deutschland), electrodes applied to the outside (see FIG. 1) with a power of about 90 watts are used to generate a nitrogen or air plasma, with a gas flow rate of about 200 ml/min. By means of an LF generator, a frequency of about 40 kHz is applied. The pressure in the interior of the rotating drum was in the range from 0.2 to 0.6 mbar, and the water-absorbing polymer structures were exposed to the plasma for a period of about 6 hours.

The starting materials used were non-surface-postcrosslinked water-absorbing polymer structures (powder A) and surface-postcrosslinked water-absorbing polymer structures (powder B).

Before and after the plasma treatment of the water-absorbing polymer structures, the retention and the FSR of powders A and B were determined. The following results shown in Table 1 were obtained:

TABLE 1

| Powder | Plasma | FSR [g/g/sec] | Retention [g/g] |
|---|---|---|---|
| A | none | 0.36 | 30.0 |
| A | N₂ | 0.39 | 30.3 |
| A | air | 0.42 | 30.5 |
| B | none | 0.25 | 29.5 |
| B | N₂ | 0.31 | 29.1 |
| B | air | 0.30 | 29.5 |

The results show that, by virtue of the plasma treatment of water-absorbing polymer structures by the process according to the invention, the absorption rate both of surface-postcrosslinked and of non-surface-postcrosslinked water-absorbing polymer structures can be improved significantly without any noticeable deterioration in retention.

### Example 2

100 g of powder A are cautiously mixed homogeneously with 0.5 g of Sipernat® 22S from Evonik Degussa GmbH in a beaker by means of a spatula, and subjected to a plasma treatment as in Example 1 to obtain powder C. The FSR values are reported in Table 2.

TABLE 2

| Powder | Plasma | FSR [g/g/sec] |
|---|---|---|
| A | none | 0.36 |
| A | N₂ | 0.39 |
| C | N₂ | 0.56 |

The results show that, over and above the significant rise in the FSR as a result of plasma treatment, the treatment with SiO₂ and plasma causes a further considerable increase in FSR.

1. A process for producing surface-modified water-absorbing polymer structures, comprising the process steps of:
I) providing a multitude of water-absorbing polymer structures; and
II) treating the surface of the water-absorbing polymer structures provided in process step I) with a plasma;
wherein the water-absorbing polymer structures provided in process step I) are based on partly neutralized, crosslinked acrylic acid;
wherein the water-absorbing polymer structures are mixed with one another during process step II); and
wherein the plasma is an at least partly ionized gas which contains a significant proportion of free charge carriers.

2. (canceled)

3. The process according to claim 1, wherein the water-absorbing polymer structures are treated in process step II) in a mixing chamber adapted to provide an alternating electrical field.

4. The process according to claim 3, wherein the mixing chamber is a rotating drum and wherein water-absorbing polymer structures are used in an amount of at most 0.8 g/cm³ of said rotating drum volume.

5. (canceled)

6. The process according to claim 1, wherein the water-absorbing polymer structures provided in process step I) are surface-postcrosslinked before, during or after process step II).

7. The process according to claim 6, wherein the surface postcrosslinking is effected by an organic chemical surface postcrosslinker.

8. The process according to claim 1, wherein the plasma is a nitrogen plasma, an air plasma or a water vapor plasma.

9. The process according to claim 1, wherein the surface of the water-absorbing polymer structures provided in process step I) is modified with the plasma within a range from 10⁻⁶ sec to 10⁶ sec.

10. The process according to claim 1, wherein the surface of the water-absorbing polymer structures provided in process step I) is modified with the plasma at a pressure within a range from 10⁻⁶ to 5 bar.

11. The process according to claim 1, wherein the water-absorbing polymer structures are mixed before or during process step II) with 0.01 to 5% by weight, based on the total weight of the water-absorbing polymer structures, of a filler.

12. The process according to claim 1, wherein the multitude of water-absorbing polymer structures is provided in process step I) mixed with a multitude of inorganic particles.

13. An apparatus for producing a plasma-treated water-absorbing polymer structure, comprising the following apparatus parts in fluid-conducting connection with one another and in direct or indirect succession:
V1) a polymerization region,
V2) a finishing region,
V3) a plasma treatment region,
where the plasma treatment region includes a plasma source and a mixing apparatus.

14. The apparatus according to claim 13, wherein a surface postcrosslinking region is provided upstream or downstream of the plasma treatment region.

15. (canceled)

16. Surface-modified water-absorbing polymer structures obtainable by the process of:
I) providing a multitude of water-absorbing polymer structures; and
II) treating the surface of the water-absorbing polymer structures provided in process step I) with a plasma;
wherein the water-absorbing polymer structures provided in process step I) are based on partly neutralized, crosslinked acrylic acid; and
wherein the water-absorbing polymer structures are mixed with one another during process step II).

17. The surface-modified water-absorbing polymer structures according to claim 16, wherein the surface-modified water-absorbing polymer structures have a free swell rate, determined by the test method described herein, of at least 0.3 g/g/sec.

18. The surface-modified water-absorbing polymer structures according to claim 16, wherein the polymer structures have an absorption under pressure, determined by the test method described herein, of at least 20 g/g.

19. Foams, moldings, fibers, foils, films, cables, sealing materials, liquid-absorbing hygiene articles, carriers for plant growth- and fungal growth-regulating compositions, packaging materials, soil additives or building materials, comprising the surface-modified water-absorbing polymer structures according to claim 16.

20. (canceled)

21. The process according to claim 1, wherein said filler comprises one or more silicon oxide compounds.

22. The process according to claim 3, wherein the electrical field has an excitation frequency within a range of from 1 to 10¹⁰ Hz.
